(19) United States
(12) Patent Application Publication
(10) Pub. No.: US 2014/0159562 A1
(43) Pub. Date: Jun. 12, 2014

(54) LIGHTING DEVICE INCLUDING OPTOELECTRONIC COMPONENT

(71) Applicant: OSRAM GmbH, Muenchen (DE)

(72) Inventors: Henrike Streppel, Regensburg (DE); Michael Rosenauer, Regensburg (DE)

(73) Assignee: OSRAM GmbH, Muenchen (DE)

(21) Appl. No.: 14/088,528

(22) Filed: Nov. 25, 2013

(30) Foreign Application Priority Data
Dec. 6, 2012 (DE) 10 2012 222 476.9

(51) Int. Cl. F21K 99/00

(52) U.S. Cl. CPC F21K 9/50
USPC 313/110

(57) ABSTRACT

In various embodiments, a lighting device may include: a light-emitting optoelectronic component; an envelope bulb, within which the component is arranged; and scattering means that scatter diffusely, wherein the scattering means are arranged in such a way that, as viewed in a sectional plane which includes a principal ray of the light emitted by the component, light emitted along rays tilted relative to the principal ray is scattered to a greater extent as the tilting angle between ray and principal ray decreases, and this increase in the scattering is fulfilled in a continuous angular range of at least 30°.

### CROSS-REFERENCE TO RELATED APPLICATION

This application claims priority to German Patent Application Serial No. 10 2012 222 476.9, which was filed Dec. 6, 2012, and is incorporated herein by reference in its entirety.

### TECHNICAL FIELD

Various embodiments relate generally to a lighting device including a light-emitting optoelectronic component and an envelope bulb, within which the component is arranged.

### BACKGROUND

In comparison with conventional incandescent or else fluorescence lamps, optoelectronic light sources developed at the present time may be distinguished by an improved energy efficiency. In the context of this disclosure, optoelectronic components based on a semiconducting material are also abbreviated to “LED”, which generally means both inorganic and organic light-emitting diodes.

If an LED can be described for example to a certain approximation as a Lambertian emitter, the light is emitted into a half-space, when expressed in a simplified manner. In order to produce an illuminant which emits light modeled on a conventional incandescent lamp, for instance, including in opposite directions, it is known in this respect from the prior art to provide a plurality of printed circuit boards populated with in each case one or a plurality of LEDs and to arrange them in a manner tilted with respect to one another, for instance as side faces of a parallelepiped.

### SUMMARY

In various embodiments, a lighting device may include: a light-emitting optoelectronic component; an envelope bulb, within which the component is arranged; and scattering means that scatter diffusely, wherein the scattering means are arranged in such a way that, as viewed in a sectional plane which includes a principal ray of the light emitted by the component, light emitted along rays tilted relative to the principal ray is scattered to a greater extent as the tilting angle between ray and principal ray decreases, and this increase in the scattering is fulfilled in a continuous angular range of at least 30°.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1A-1 B show a lighting device according to various embodiments in a sectional illustration that illustrates the profile of the scattering coefficient;

FIGS. 2A-2C show various possibilities for setting a corresponding profile of the scattering coefficient;

FIG. 3 shows the propagation of individual light paths in a lighting device according to various embodiments; and

FIG. 4 shows the intensity profile of the lighting device according to FIG. 3 downstream of the envelope bulb.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments are based on the object of specifying a lighting device which is advantageous relative to a conventional lighting device.

Various embodiments provide a lighting device including an envelope bulb, within which the light-emitting optoelectronic component (designated hereinafter by “component” or “LED”) is arranged, and including scattering means that scatter diffusely (the light emitted by the component), said scattering means being provided in such a way that, as viewed in a sectional plane (in which lies a principal ray of the light emitted by the component), light emitted along rays tilted by a tilting angle relative to the principal ray is scattered to a greater extent as the tilting angle decreases; in this case, the scattering increases in a continuous angle range of at least 30°, in this order increasingly preferably of at least 40°, 50°, 60°, 70° or 80°.

The principal ray is formed as an average value of all unscattered light paths emitted by the component and weighted according to power and is regularly a symmetry-governed center axis. The nadir of the principal ray lies on the light exit surface of the component; the position within the light exit surface then depends on the emission characteristic of the component and, for symmetry reasons and in particular in the case of a Lambertian emitter, may coincide with the surface midpoint, for instance the center of a rectangular light exit surface. The following considerations then relate to a sectional plane in which said principal ray lies (which therefore intersects the component perpendicularly, for example).

When expressed in a simplified manner, in the case of the lighting device according to the invention, light emitted along rays is scattered to an extent that is all the greater, the “nearer” the rays are to the principal ray, that is to say the smaller the tilting angle that the respective ray forms with the principal ray. In other words, the scattering coefficient is intended to increase as the tilting angle decreases.

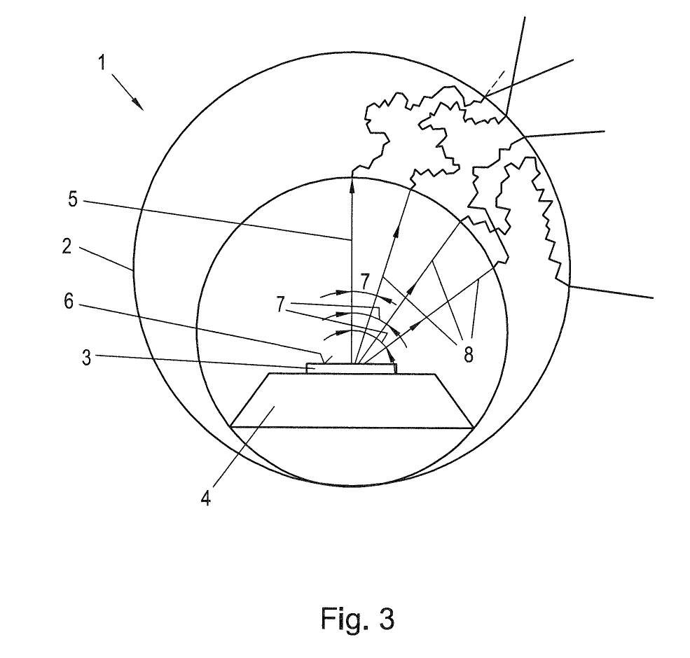

In the context of this disclosure, “ray” means a geometric ray, the nadir of which lies in the light exit surface. By contrast, a “light path” is a concept for describing or modeling the light that is (firstly) emitted along a geometric ray but then indeed deviates therefrom (for instance owing to the scattering) in the further propagation (FIG. 3 illustrates the difference between “ray”/“light path” on the basis of a so-called ray tracing simulation). In this respect, the statement “light emitted along a ray” relates to an average value formed over a multiplicity of light paths emitted along the ray, or to a direction-resolved intensity measurement.

With the scattering coefficient increasing toward the principal ray, that is to say with the scattering becoming “greater” in the angular range, as a consequence the intensity of the light emitted in the direction of the principal ray (or in a direction near the latter), downstream of the envelope bulb, is reduced by scattering to a greater extent than the intensity of the light emitted in a “lateral” direction (direction remote from the principal ray), in each case compared with the intensity directly downstream of the component; the reduction of the intensity respectively emitted along the rays as a result of scattering increases in the angular range as the tilting angle decreases.

If scattering particles, for instance, are provided as scattering means, the “density” thereof can be correspondingly increased toward the principal ray, such that, for example, the number of scattering centers respectively intersected by the rays increases as the angle between ray and principal ray decreases, or the density of scattering particles increases along the surface of the envelope bulb toward the principal ray (both result in scattering becoming “greater”).

In the last-mentioned case, on the envelope bulb, for example, a scattering particle layer of constant thickness could also be provided and correspondingly structured, for instance a closed layer could be present near the principal ray, said layer being increasingly interrupted with increasing distance therefrom (the density of scattering particles per area element increases toward the principal ray). Equally, the scattering properties could for example also be set by a roughening of the surface of the envelope bulb and the scattering cross section would be increased according to various embodiments with a roughness increasing toward the principal ray.

The light is “scattered diffusely” at the scattering centers, which, in the context of the present disclosure, very generally denotes an interaction which results in a light propagation in a direction deviating from the original direction; the resulting directions are distributed to a greater extent, to be precise randomly distributed in contrast to an imaging/“imaging scattering”. The random distribution in this respect concerns a macroscopic consideration in which, for modeling statistically distributed scattering particles, for instance, rather than the position and/or form of each particle being imaged, an average particle distance is considered, for example.

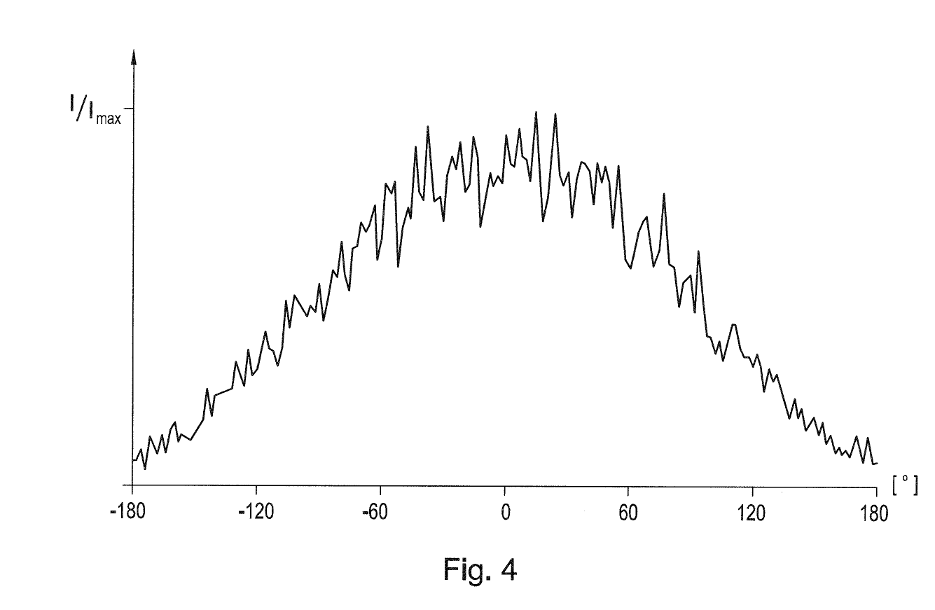

If, therefore, in the case of an imaging with a lens, for example, the course of each individual light path downstream of the imaging is fixed, by contrast the change in direction of a light path in the case of diffuse scattering as considered macroscopically is subject virtually to a random distribution; the above-described attenuation of the intensity in the principal ray direction arises for example only by averaging over a multiplicity of light paths. Light paths emitted successively along the same ray are also randomly distributed in each case and thus deflected in different directions; the distribution of the intensity results on average (cf. FIG. 3 and FIG. 4). The increase in the scattering coefficient toward the principal ray therefore results in an increase in the probability of scattering or scattering by a larger angle (also on account of a plurality of successive scattering processes).

According to various embodiments, the scattering is intended to increase in a “continuous” angular range, that is to say in an uninterrupted angular range which does not arise only as a result of addition of angular ranges spaced apart from one another. The increase in the scattering concerns at least one compensating straight line placed in the angle-dependent profile of the scattering (of the scattering coefficient) (a linear fit to the profile rises as the angle decreases); in general, therefore, for example, a periodic fluctuation can also be superimposed on the increase (it can therefore also decrease a little in sections within the angular range), for instance in the case of an envelope bulb having a macroscopically correspondingly structured, for example wavy, surface.

In general, the scattering coefficient can have a profile also comparable to a step function, for example; preference is thus given to a continuous profile and in particular also a continuous increase, that is to say not just an increase on average, but scattering that becomes exclusively greater in the angular range. In other words, the change in the scattering, that is to say the gradient of the scattering coefficient, in the angular range toward the principal ray is preferably continuously positive.

The “lighting device” can be an illuminant, for example, that is to say, when inserted into a luminaire, can then serve for lighting and be exchangeable; in general, however, “lighting device” is intended for example also to mean a device which is itself directly connected to an electrical supply and is not further inserted into a luminaire body (the lighting device can therefore also itself be a luminaire).

In so far as reference is made to the propagation of light in the context of this disclosure, this of course does not imply that a light propagation actually has to be effected in order to fulfill the subject matter; rather, a device is described which is designed for a corresponding light propagation (the light propagation is then effected only during the operation of the lighting device).

Further configurations can be found in the dependent claims and in the description below, wherein, in the course of the presentation of the features, a distinction is not always drawn specifically between the different categories of the various embodiments; the disclosure in any case implicitly relates both to a lighting device and to the use thereof.

The scattering means may be provided at the envelope bulb wall, that is to say for example as a layer particularly preferably directly adjoining said wall, and/or embedded into the envelope bulb wall; in the case of a roughened surface, too, the scattering means are provided at the envelope bulb wall. In general, however, a scattering coefficient increasing toward the principal ray could for example also be achieved with scattering means embedded uniformly into a volume material of an envelope bulb embodied as a solid body; an adaptation of the scattering coefficient would then be possible by way of the ray-dependent “thickness” of the solid body.

In various embodiments, however, the envelope bulb is a hollow body and the scattering means are provided at the envelope bulb wall with the density increasing toward the principal ray; this may be of interest for instance with regard to a reduced material requirement and concerning a possibly reduced manufacturing outlay.

In various embodiments, scattering particles are provided as scattering means, for example aluminum oxide and/or titanium dioxide particles; with further preference, these are then applied to the envelope bulb as a layer, if appropriate also embedded into a matrix material, for example by spreading, spraying, dispensing or else in a printing method. The increasing scattering coefficient can be set for example by way of the density of the scattering particles in the layer and/or the layer thickness and a corresponding increase thereof.

In various embodiments, the angular range, as viewed in the sectional plane, directly adjoins the principal ray, that is to say that light emitted along the principal ray centroidally by definition is also scattered to the greatest extent; the scattering (the scattering coefficient) increases in the angular range toward the principal ray and, in the case of an angular range adjoining the principal ray, accordingly also has a maximum there.

In various embodiments, the scattering is additionally increased in the region of the principal ray, that is to say that the increase in the scattering (the gradient of the scattering coefficient) is locally greater in the region than in an adjacent region. In the adjacent region, therefore, the scattering can increase for example substantially uniformly (the gradient can be constant); in the region of the principal ray, by contrast, the gradient would be greater and could rise for example continuously or abruptly. The scattering can thus be additionally increased in an “increasing angular range”—adjoining the principal ray—of, for example, at least 5°, 10° or 15°.

Generally, the scattering means are preferably inert scatterers, that is to say that the light does not interact with the scattering means over and above the randomly distributed deflection, and so in particular its wavelength remains unchanged. In general, however, for example, a phosphor could also be provided as scattering means because it can absorb light (pump light) propagating in a specific direction and can subsequently emit light converted in a more or less randomly distributed manner with regard to the directions.

However, a disadvantage might result therefrom in so far as the degree of conversion could then also vary in a direction-dependent manner, that is to say that the proportion of converted light could increase for example as the tilting angle decreases. As a result, light of different colors would be emitted in different directions, for which reason inert scatterers, for example scattering particles that do not change the wavelength of the light or a matt surface finish, are provided in various embodiments.

In various embodiments, the scattering particles are embedded into the envelope bulb wall; it is thus possible to prevent for example a degradation of the scattering particles owing to an interaction with ambient air or mechanical damage to the scattering means in the event of handling errors, for example scratching.

In various embodiments, the thickness of the envelope bulb wall in this case increases in the angular range toward the principal ray, that is to say that the scattering particles are distributed for example substantially uniformly in the envelope bulb wall and the scattering/scattering coefficient is set by way of the wall thickness.

This may be advantageous for instance also in so far as, in various embodiments, the envelope bulb is constructed in a translationally symmetrical manner perpendicularly to the sectional plane and, particularly preferably, is produced by extrusion. By means of a corresponding design of ram and die, a profile having a wall thickness that increases along the envelope bulb wall (toward the principal ray) can also be produced as an extruded profile and thus as far as possible in a cost-optimized manner.

In this respect, too, a plastics material is preferred for the envelope bulb, wherein polycarbonate and respectively polymethyl methacrylate are provided in various embodiments. An envelope bulb composed of plastics material can for example also be distinguished by durability to withstand mechanical fracture or by a reduced weight.

The scattering means provided at the envelope bulb wall in various embodiments may be provided not only where the light emitted by the component and not yet scattered is incident (directly) on the envelope bulb wall, but also in a shaded region (apart from the light distribution as a result of scattering). In other words, therefore, for example, not only the region of the envelope bulb which lies in the half-space through which the principal ray passes is provided with scattering means, but also a region thereof which lies in the opposite half-space (“back space”), in any case partly. In other words, correspondingly provided scattering means then also distribute the light already scattered beforehand further toward the side and in particular in a direction opposite to the principal ray.

In this regard, too, a lighting device according to various embodiments can be combined advantageously with a luminaire having a reflector; this is because the luminaire can be designed for example for a conventional fluorescent lamp, such that an optimum light distribution can only be achieved if the reflector is also illuminated. This last can be set by the scattering means provided in the manner according to various embodiments.

Generally, various embodiments also relate to a corresponding use, that is to say the use of a lighting device according to various embodiments, e.g. of an illuminant, as a part appropriate for a conventional base of a luminaire, e.g. as a retrofit part. Particular preference is given to the use as a replacement or retrofit part for a fluorescent lamp of the “T” type, for instance T2, T3, T4, T5 or T8 or T12.

In various embodiments, as viewed in the sectional plane, the envelope bulb therefore has a round outer contour, e.g. a circular outer contour. Generally, preference is also given to the distribution of the scattering means concerning a symmetrical construction, to be precise, as viewed in the sectional plane, with the principal ray as axis of symmetry; generally, the scattering preferably increases from two sides toward the principal ray, e.g. mirror-symmetrically.

Since a good light distribution to the sides or even into the back space can be achieved with the scattering means, the components preferably provided as a plurality are in various embodiments arranged with principal rays that are directed into the same half-space and e.g. are parallel; e.g. the components are mounted in a common mounting plane, that is to say for example on a common substrate, for instance a printed circuit board.

By way of example, it is not necessary for a plurality of printed circuit boards to be mounted in a manner tilted with respect to one another or for three-dimensional structures to be populated at different sides in a complex manner, which can help to simplify production and also reduce costs. Generally, a rear-side region of the components can be used for cooling means for example, wherein, in the case of a single mounting plane of the components, the configuration thereof is also simplified.

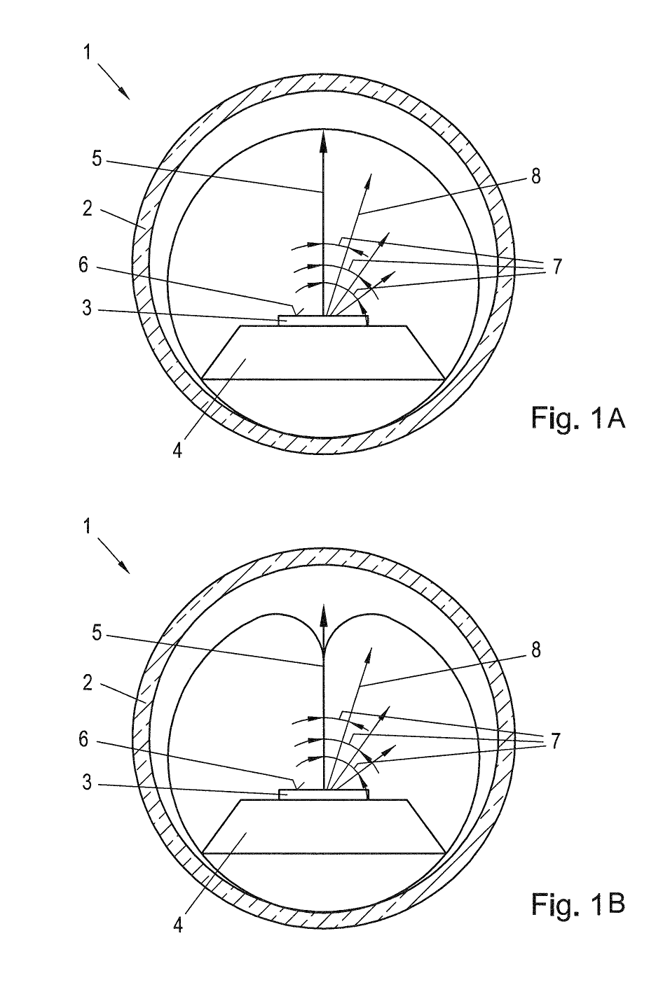

FIG. 1A shows a lighting device 1 according to various embodiments including an envelope bulb 2 and an LED 3 provided within the envelope bulb 2. The LED 3 is mounted on a heat sink 4 and emits light centroidally along a principal ray 5, to be precise at an exit surface 6.

The arrangement shown in FIG. 1A is constructed in a translationally symmetrical manner perpendicularly to the plane of the drawing, which corresponds to a sectional plane including the principal propagation direction 5. The envelope bulb 2 is an elongate, tubular body in which a plurality of LEDs are provided at a certain distance from one another.

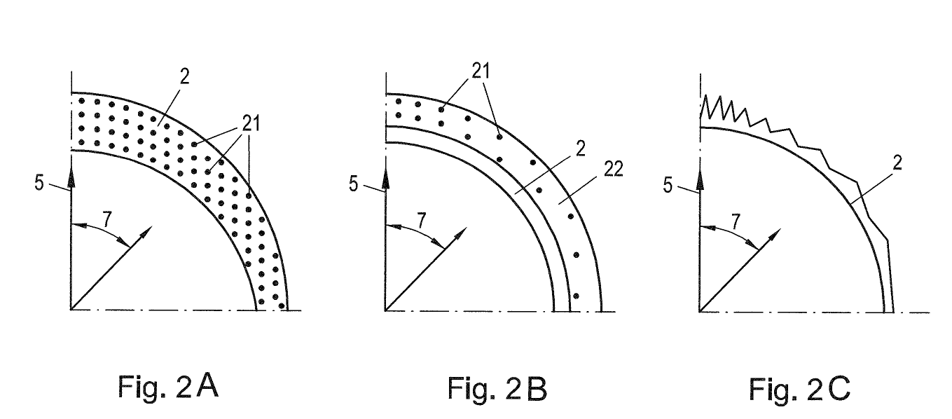

In various embodiments, then, a scattering coefficient that increases toward the principal ray 5 is set along the envelope bulb wall (with regard to different possibilities for setting the scattering coefficient, reference is made to FIG. 2); the smaller a tilting angle 7 between the principal ray 5 and a ray 8 tilted with respect thereto, the greater the extent to which light emitted along the corresponding ray 8 is scattered. Consequently, the intensity of the light emitted along a ray 8 with a small tilting angle 7, downstream of the envelope bulb 2, is attenuated by scattering to a greater extent.

Light emitted in the direction of the principal ray 5 or in a direction near the latter is thus distributed at least partly toward the sides, which approximates the emission characteristic of the lighting device 1 to that of a conventional fluorescent lamp.

FIG. 1A (and also FIG. 1B) schematically illustrates the profile of the scattering coefficient as a curve running along the envelope bulb (within the latter) (the greater the distance between curve and envelope bulb wall, the greater the scattering coefficient). The scattering coefficient increases from a zero point, which lies in an opposite direction to the principal ray 5 (6 o'clock position), along the envelope bulb wall in the two opposite circumferential directions toward the principal ray 5; in each circumferential direction, therefore, the increase extends over an angular range of 180°.

Scattering means are provided not only in the region of the envelope bulb 2 on which the light emitted by the LED 3 impinges directly (the light emission is Lambertian in the present case), but also in a rear-side region (in the back space). Therefore, the light is distributed not only in an intensified fashion toward the side, but also into the back space as a result of multiple scattering processes.

FIG. 1B illustrates an embodiment which differs from that according to FIG. 1A in the profile of the scattering coefficient in a region around the principal ray 5, but otherwise is structurally identical thereto. In the region near the principal ray 5, the scattering coefficient increases more than proportionally, that is to say that the gradient of the scattering coefficient is greater than otherwise from the 6 o'clock position toward the principal ray 5.

Light emitted in the direction of the principal ray 5 is thus scattered to an even greater extent; the intensity downstream of the envelope bulb 2 is accordingly also attenuated more than proportionally. More light is distributed toward the sides or into the back space.

FIG. 2 illustrates various possibilities for setting a scattering coefficient that increases toward the principal ray 5 according to various embodiments.

In the case of the embodiment in accordance with FIG. 2A, scattering particles 21, in this case aluminum oxide particles, are embedded into the wall of the envelope bulb, to be precise in a substantially uniformly distributed manner, that is to say with an average particle distance which remains substantially the same along the envelope bulb wall. However, by virtue of the fact that the thickness of the envelope bulb wall increases toward the principal ray 5, as the tilting angle 7 decreases, the number of scattering particles 21 per ray 8 also increases and accordingly so does the probability of a deflection or a deflection by a larger angle. Such an envelope bulb 2 can be produced from polycarbonate by extrusion, for example.

In the case of the embodiment in accordance with FIG. 2B, a coating 22 is provided on the envelope bulb 2, that is to say that the scattering particles 21 embedded in a matrix material are applied to the envelope bulb 2. The thickness of the coating is substantially constant along the envelope bulb wall 2; however, the average particle distance decreases as the tilting angle 7 decreases, that is to say that the density of the scattering particles 21 and thus the scattering coefficient are increased.

As a result, light emitted along the principal ray 5 is scattered to a greater extent than light emitted toward the side, that is to say that downstream of the envelope bulb 2 (or the coating 22) the intensity is attenuated in the direction of the principal ray 5 and intensified toward the side, to be precise because light is redistributed by the scattering.

In the case of the embodiment in accordance with FIG. 2C, no scattering particles 21 are provided, rather the outer surface of the envelope bulb 2 is roughened, for example by etching or sandblasting. In this case, the roughness increases as the tilting angle 7 decreases toward the principal ray 5; the scattering coefficient correspondingly increases, and the light is scattered to a greater extent as the tilting angle 7 decreases.

FIG. 3 illustrates in a schematic illustration the propagation of four light paths emitted along rays 8 having different tilting angles 7 (on the basis of a ray tracing simulation; in the context of such simulations, a “light path” is also designated as a “light ray”, the propagation of which is then calculated).

The envelope bulb having scattering properties according to the invention is modeled by means of a layer whose thickness increases toward the principal ray 5 in a manner corresponding to the embodiment in accordance with FIG. 2A; within the layer, the scattering is subject to a random distribution and this random distribution is constant along the envelope bulb wall (which corresponds to the uniformly distributed scattering particles in accordance with FIG. 2A).

For light emitted along the rays 8, as the tilting angle 7 decreases, the layer thickness to be penetrated (the “sample depth”) increases, such that light emitted along the principal ray 5 on average is scattered to a greater extent—on account of the random distribution of the scattering, although individual light paths emitted at a large tilting angle may indeed (despite the smaller “sample depth”) cover a longer path in the scattering layer, on average (over a multiplicity of light paths) the intensity is attenuated in the direction of the principal ray 5.

The light paths propagate from the light exit surface 6 of the component 3 linearly (along the rays) as far as the scattering layer and are subsequently deflected in each case by a multiplicity of successive scattering processes, to be precise in a randomly distributed manner with each scattering process. The simulated light paths therefore cover in each case a path that is subject to a random distribution with regard to free path length between two scattering processes and deflection during a scattering process; correspondingly, a light path downstream of the scattering layer is then tilted relative to its original direction of propagation.

The light propagation toward the side or into the back space is furthermore also improved by total reflections—light paths impinging at an angle which is greater than the critical angle dependent on the refractive indices of the scattering layer (the envelope bulb wall with embedded scattering particles) and of the surrounding medium do not emerge from the scattering layer, but rather are reflected back into the latter.

FIG. 4 illustrates, as the simulation result, the profile of the intensity for the arrangement in accordance with FIG. 3, that is to say an averaging over a multiplicity of simulated light paths. The 0° value is taken at the 12 o'clock position in accordance with FIG. 3 (that is to say at the top in FIG. 3); in the counterclockwise direction (up to −180°) and in the clockwise direction (up to 180°) the intensity decreases, that is to say that light is emitted (still) the most into the half-space in which the principal ray 5 lies.

Without the scattering layer provided according to the invention, however, light would only be emitted into this half-space, that is to say that the intensity would be equal to zero already at +/−90° and for the entire back space. The scattering layer reduces (downstream of the envelope bulb 2) the intensity of the light emitted in the direction of the principal ray and distributes light into the back space (−90° to −180° and 90° to 180°).

The lighting device may be used as a lighting device appropriate for a conventional base of a luminaire, e.g. a luminaire with reflector, e.g. as a retrofit part for such a luminaire.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lighting device, comprising:
a light-emitting optoelectronic component;
an envelope bulb, within which the component is arranged; and
scattering means that scatter diffusely,
wherein the scattering means are arranged in such a way that, as viewed in a sectional plane which includes a principal ray of the light emitted by the component, light emitted along rays tilted relative to the principal ray is scattered to a greater extent as the tilting angle between ray and principal ray decreases, and this increase in the scattering is fulfilled in a continuous angular range of at least 30°.

2. The lighting device of claim 1,
wherein the scattering means are provided at the envelope bulb wall and, as viewed in the sectional plane, the density of the scattering means increases in the angular range along the envelope bulb wall toward the principal ray.

3. The lighting device of claim 1,
wherein, in the angular range, a profile of the scattering is continuous.

4. The lighting device of claim 3,
wherein, in the angular range, the scattering exclusively increases.

5. The lighting device of claim 1,
wherein the angular range, as viewed in the sectional plane, directly adjoins the principal ray.

6. The lighting device of claim 1,
wherein the scattering, as viewed in the sectional plane, is additionally increased in a region around the principal ray, that is to say that the increase in the scattering is locally greater than in an adjacent region.

7. The lighting device of claim 1,
wherein an inert scatterer is provided as scattering means.

8. The lighting device of claim 2,
wherein scattering particles applied to the envelope bulb as a coating are provided as scattering means.

9. The lighting device of claim 2,
wherein scattering particles embedded into the envelope bulb wall are provided as scattering means.

10. The lighting device of claim 9,
wherein the thickness of the envelope bulb wall, as viewed in the sectional plane, increases in the angular range toward the principal ray.

11. The lighting device of claim 1, further comprising:
a plurality of components, wherein all the components are provided with principal rays directed into the same half-space and are preferably arranged in a common mounting plane.

12. The lighting device of claim 2,
wherein scattering means are also provided in a region of the envelope bulb wall on which light emitted by the component is not directly incident.

13. The lighting device of claim 12,
wherein scattering means are also provided in a region of the envelope bulb wall on which light emitted by the component is not directly incident with a density that increases along the envelope bulb wall toward the principal ray.

14. The lighting device of claim 1,
wherein the envelope bulb is constructed in a translationally symmetrical manner perpendicularly to the sectional plane.

15. The lighting device of claim 14,
wherein the envelope bulb is an extruded profile.

16. The lighting device of claim 1,
wherein the envelope bulb is provided in a manner composed of a plastics material.

17. The lighting device of claim 16,
wherein the envelope bulb is provided in a manner composed of at least one of polycarbonate and polymethyl methacrylate.
